(19) United States
(12) Patent Application Publication
(10) Pub. No.: US 2007/0144319 A1
(43) Pub. Date: Jun. 28, 2007

(54) SCOR-GUIDE ACCESSORY FOR A CIRCULAR SAW OR ROUTER

(76) Inventor: Robert G. Jones, Modesto, CA (US)

Correspondence Address: PATENTS PENDING, 9832 LOIS STILTNER CT, ELK GROVE, CA, 95624, US

(21) Appl. No.: 11/565,721

(22) Filed: Dec. 1, 2006

Related U.S. Application Data
(60) Provisional application No. 60/754,028, filed on Dec. 27, 2005.

(51) Int. Cl. B26D 1/00; B27B 21/00

(52) U.S. Cl. 83/13; 83/745

(57) ABSTRACT

A SCOR-GUIDE system comprises an extruded aluminum fence that is permanently fastened to a sliding bar clamp. The fence has a horizontally protruding tab on the side that is trimmed by the user to match the saw or router that will be used with it. A metal-cutting blade or bit is temporarily fitted in the power tool and used to cut the underlying tab the exact distance from the vertical part of the fence. The regular blades or bits are then returned to the power tool for normal use. Sheet materials can then be precisely cut along the straight line provided by the fence, and the prepared tab will protect the sheet material from marring and chipping during cutting.

### RELATED APPLICATIONS

Applicant claims priority from U.S. Provisional Patent Application 60/754,028, filed Dec. 27, 2005.

### BACKGROUND

1. Field of the Invention

The present invention relates to power tools, and more particularly to methods and devices for guiding a circular saw or router along a line of cutting.

2. Description of the Prior Art

Fences and other devices have been used to make precise, straight, or curved cuts in wood or other materials. Circular saws and routers typically include base plates that support the weight of the tool on the material and keep the blades and bits at a constant angle. These base plates have large openings all around the blades and bits so the user can see the progress of the work and so they can follow any marks on the material.

Many materials will flake, rip, and tear on the top side as they are being cut. Wood is especially prone to doing this on the working side if the wood is dry and delicate, or the blade is not fine-toothed. Putting the finish side down, scoring with a knife, and backing the material are all ways craftsmen have used to improve the finished results.

Nice straight cuts in sheet materials can be made by clamping a guide to the wood and running a loose circular saw against one edge. Another way commonly found in Home Depot stores, is to mount a saw on a sliding rail or arm, and clamp the sheet material into the fixture underneath. The saw will then make a clean, straight cut as it passes over the material.

### SUMMARY OF THE INVENTION

Briefly, a SCOR-GUIDE system embodiment of the present invention comprises an extruded aluminum fence that is permanently fastened to a sliding bar clamp. The fence has a horizontally protruding tab on the side that is trimmed by the user to match the saw or router that will be used with it. A metal-cutting blade or bit is temporarily fitted in the power tool and used to cut the underlying tab the exact distance from the vertical part of the fence. The regular blades or bits are then returned to the power tool for normal use. Sheet materials can then be precisely cut along the straight line provided by the fence, and the prepared tab will protect the sheet material from marring and chipping during cutting.

An advantage of the present invention is that a tool and method are provided for users to make clean precise cuts with power tools.

Another advantage of the present invention is that a SCOR-GUIDE system is provided that can be prepared to precisely match the fence-to-blade dimensions of particular power tools used.

A further advantage of the present invention is that a SCOR-GUIDE system is provided that protects sheet material being cut from being marred by the power tool base and reduces chipping.

A still further advantage of the present invention is that a SCOR-GUIDE system is provided that gives an exact edge for scoring the sheet material with a knife before cutting.

These and other objects and advantages of the present invention will no doubt become obvious to those of ordinary skill in the art after having read the following detailed description of the preferred embodiments which are illustrated in the various drawing figures.

### IN THE DRAWINGS

FIG. 1A is a perspective view diagram of a SCOR-GUIDE system embodiment of the present invention as it is being assembled for the first time and before being prepared for use with a particular power tool;

FIG. 1B is an end view diagram of a circular saw power tool fitted with a metal-cutting blade and being used to prepare the horizontal tab of a fully assembled SCOR-GUIDE system embodiment of the present invention;

FIG. 2 is a perspective view of just the metal-cutting blade of FIG. 1B and how it is used to prepare the horizontal tab of the fully assembled SCOR-GUIDE system;

FIG. 3 is an end view diagram of the circular saw power tool of FIG. 1B now fitted with a wood-cutting blade and being used to cut a piece of plywood. The prepared horizontal tab of the SCOR-GUIDE system lays over the edge of the plywood and provides a clamped-on fence for the saw and chipping protection for the finished cut;

FIG. 4 is a perspective view of the wood-cutting blade of FIG. 3 and how the fully assembled SCOR-GUIDE system is put to work in normal use;

FIG. 5 is an end view diagram of a router fitted with a typical bit and being used to cut a sheet of plastic. The prepared horizontal tab of the SCOR-GUIDE system lays over the edge of the sheet material and provides a clamped-on fence for the saw and chipping protection for the finished cut.

FIG. 6 is an end view diagram of the circular saw power tool like in FIG. 1B but prepared to have the motor side of the circular pass over the bar clamp. It is this case that would use a 6″ wide horizontal tab on the fence. The saw is fitted with a wood-cutting blade and being used to cut a piece of plywood. The prepared horizontal tab of the SCOR-GUIDE system lays over the edge of the plywood and provides a clamped-on fence for the saw and chipping protection for the finished cut.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENT

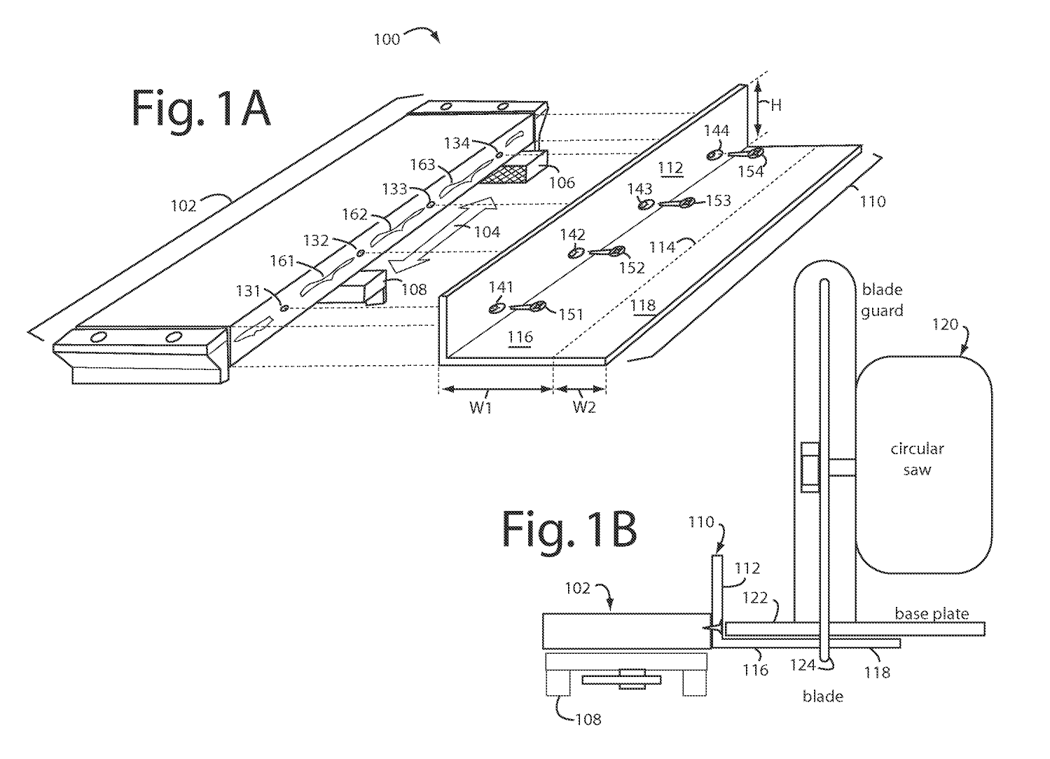

FIG. 1A represents a SCOR-GUIDE™ system embodiment of the present invention, and is referred to herein by the general reference numeral 100. The SCOR-GUIDE system 100 comprises a sliding-bar clamp 102 for clamp onto sheet materials like plywood. An adjustable clamping span 104 is provided by a fixed end stop 106 and a sliding stop 108. A fence 110 comprises an angle bar, such as an extruded aluminum body with a L-shape profile, e.g., one inch tall and two inches wide. Plastic material could also be used in cases where the user is reluctant to cut aluminum stock.

A vertical wall 112 is fastened to the bar clamp 102 with screws and cyanoacrylate type adhesive. A series of standardized fences 110 are made commercially practical by always drilling the screw holes in the same places on sliding-bar clamp 102 and fence 110. Standard lengths of 24″, 36″, and 50″ are desirable, with cutting tab widths of 2″ or 6″. Such combinations will accommodate the majority of sheet materials and power tools being used on them.

A line 114 represents the cutting/scoring edge that will match a particular circular saw or router after preparation. Such line is cut with the intended saw or router fitted with a metal cutting blade or bit. The base plate of the power tool is pressed up against the vertical wall 112 and run down its length from end to end like a rip fence. An inside strip 116 represents working edge piece that will remain after an outside strip 118 is cut away and the sharp edges are rounded off.

After the preparation of FIG. 1A is complete, the inside strip 116 will be able to help control chipping and prevent marring of the sheet material because it will be clamped tightly along the exact cutting line of the saw or router. To further reduce chipping, a scoring knife can run along the sheet material on edge of inside strip 116 before using a saw to finish the cut.

FIG. 1B shows how the cutting guide system 100 would be prepared for use after assembly. A circular saw 120 with a base plate 122 is run tight along side vertical wall 112. A metal-cutting blade 124 cuts and separates outer strip 118 from inner strip 116.

Returning to FIG. 1A, a standard series of screw holes 131-134 are provided in the bar clamp 102. These match the size, position, and spacing of corresponding countersunk screw holes 141-144 in fence 110. Such provides for an interchangeability amongst several standard size length and width fences 110 that can be installed in a single bar clamp 102. Flat head sheet metal screws 151-154, for example, are used in conjunction with beads of cyanoacrylate adhesive 161-163 to hold the assembly firmly together.

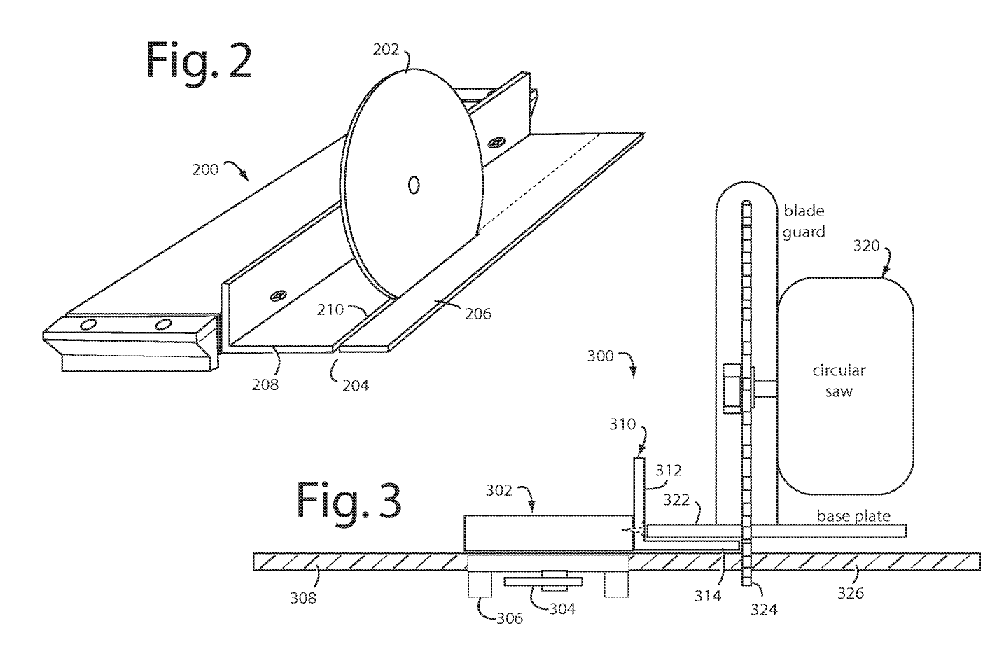

FIG. 2 shows a SCOR-GUIDE system 200 being prepared to fit a particular circular saw. A metal-cutting blade 202 is installed in a circular saw (like saw 120 in FIG. 1B), and a cut 204 is made the whole length. Eventually, a piece 206 will be separated, leaving only a score tab 208 with an outside scoring edge 210. This is lightly sanded or filed before using to remove sharp edges. A regular blade, such as for wood, laminates, or plastics replaces blade 202 in the saw. Such saw and SCOR-GUIDE system 200 are then after matched to each other.

FIG. 3 shows a fully prepared SCOR-GUIDE system 300 being used with the particular circular saw it was matched to. A bar clamp 302 includes a lever 304 that presses an end grip 306 to clamp onto a sheet material 308. For example, plywood would be a typical sheet material. An extruded aluminum angle fence 310 is permanently secured to the bar clamp 302. A vertical tab 312 provides a fence and a horizontal tab 314 provide a support for a circular saw 320. Its base plate 322 dictates the distance from vertical tab 312 and a saw blade 324. An end piece 326 of sheet material 308 will be removed when the cut is complete.

Since the fence 310 was previously prepared using a metal cutting blade in saw 320, the length of horizontal tab 314 will exactly match the distance to wood cutting blade 324. The outer edge of horizontal tab 314 will lie over and protect the finished edge of sheet material 308 during cutting. Such protection will guard against marring of the surfaces and chipping along the edges.

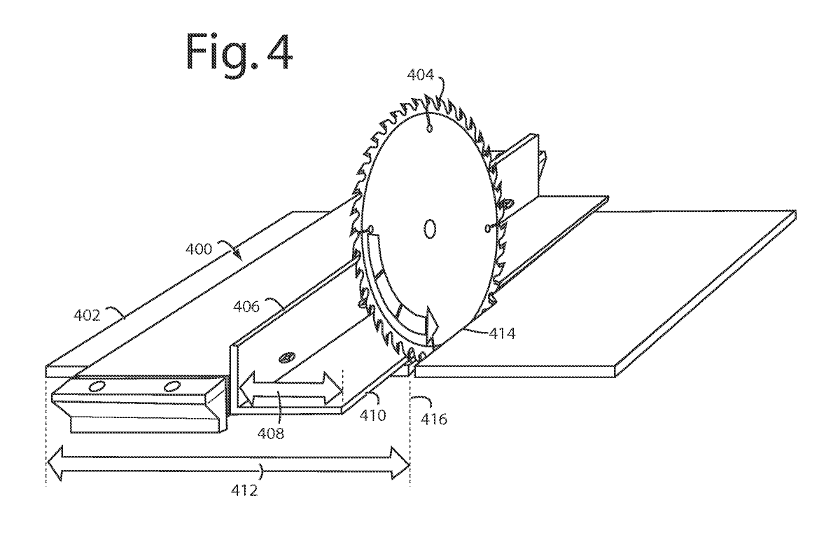

FIG. 4 is similar to FIG. 3, but in perspective view. A fully prepared SCOR-GUIDE system 400 being used with the particular circular saw for which it was matched. A piece of plywood 402 is to be cut by a saw blade 404. The rest of the circular saw is not shown here so other details will not be obscured. An aluminum angle fence 406 has been prepared with a horizontal tab width 408 that exactly matches the circular saw. A scoring edge 410 is aligned at the desired cut width 412. Blade 404 then can make a cut 414 precisely along edge 416.

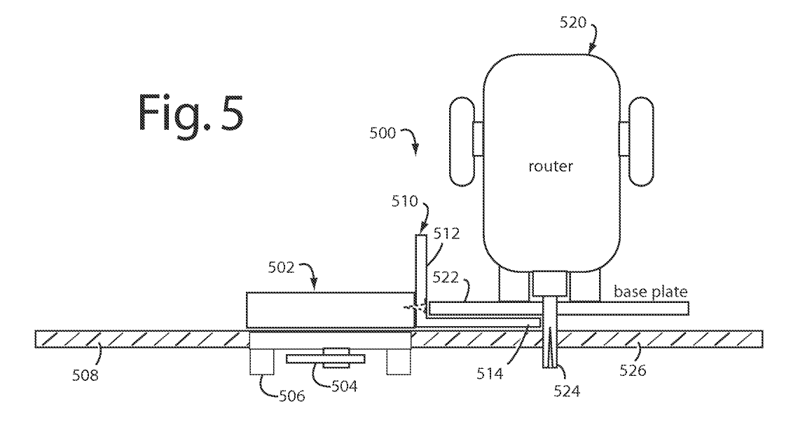

FIG. 5 shows a fully prepared SCOR-GUIDE system 500 being used with a particular router for which it was matched. A bar clamp 502 includes a lever 504 that presses an end grip 506 to clamp onto a sheet material 508. For example, plastic laminate would be a typical sheet material. An extruded aluminum angle fence 510 is permanently secured to the bar clamp 502. A vertical tab 512 provides a fence and a horizontal tab 514 provide a support for a router 520. Its base plate 522 dictates the distance from vertical tab 512 and a router bit 524. An end piece 526 of sheet material 508 will be removed when the cut is complete.

Since the fence 510 was previously prepared using a metal cutting bit in router 520, the length of horizontal tab 514 will exactly match the distance to working bit 524. The outer edge of horizontal tab 514 will lie over and protect the finished edge of sheet material 508 during cutting. Such protection will guard against marring of the surfaces and chipping along the edges.

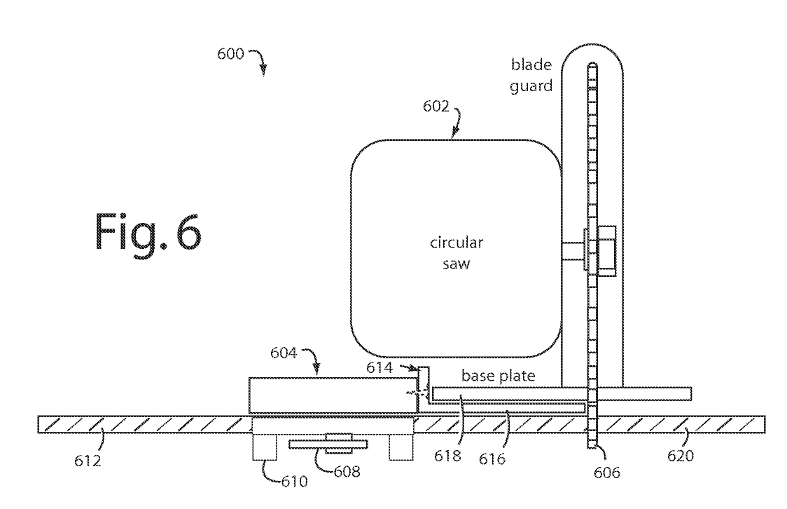

FIG. 6 shows a fully prepared SCOR-GUIDE system 600 being used with a particular circular saw 602 it was matched to with the saw motor on a bar clamp 604 side of a blade 606. Such bar clamp 604 includes a lever 608 that presses an end grip 610 to clamp onto a sheet material 612. For example, plywood would be a typical sheet material. An extruded aluminum angle fence 614 is permanently secured to the bar clamp 604 with sheet metal screws. A vertical tab provides a fence and a much wider horizontal tab 616 that was cut from a 6″ width. Such provides support for the motor side of the circular saw 602. The outside edge of the base plate 618 on the motor side is held to the inside corner of the fence 614. The distance of the outside edge of the base plate 618 on the motor side to the saw blade 606 determines how wide horizontal tab 618 should be cut during preparation. Once prepared, and a wood-cutting blade is installed as shown in FIG. 6, an end piece 620 of sheet material 612 will be removed along the exact scoring line on the distal edge of horizontal tab 616.

Since the fence 614 was previously prepared from a 6″wide stock piece using a metal cutting blade in saw 620, the width of horizontal tab 616 will exactly match the distance to wood cutting blade 606. Compare the width to that in FIG. 3 where the motor side of the circular saw is opposite to the bar clamp. Here, the motor must clear the bar clamp 604. To do this, the saw blade height adjustment is critically set. The outer edge of horizontal tab 616 will lie over and protect the finished edge of sheet material 612 during cutting. Such protection will guard against marring of the surfaces and chipping along the edges.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

What is claimed is:

1. A power tool accessory, comprising:
a bar clamp for temporary attachment to sheet material by gripping its edges; and
an angle bar with unequal legs and fastened to one long side of the bar clamp;
wherein, a lateral leg of the angle bar provides for a scoring edge during use.

2. The power tool accessory of claim 1, further comprising:
a match series of screw holes in both the bar clamp and the angle bar such that a number of different size lengths and widths of angle bars can be interchanged and joined with the bar clamp.

3. The power tool accessory of claim 1, further comprising:
a bead of cyanoacrylate type adhesive between the bar clamp and the angle bar, and providing for a stronger attachment.

4. The power tool accessory of claim 1, further comprising:
a scoring line and straight edge provided along said lateral leg of the angle bar that was cut by a particular power tool that is thereafter mated for its use.

5. The power tool accessory of claim 1, wherein:
the scoring line and straight edge is relieved of sharp edges.

6. The power tool accessory of claim 1, wherein:
the scoring line and straight edge provides for reduced chipping of sheet material being cut by said power tool.

7. The power tool accessory of claim 1, wherein:
the angle bar comprises at least one of extruded aluminum and plastic.

8. A method for making straight cuts in sheet materials, comprising:
selecting a bar clamp able attach itself to sheet materials by gripping the outside edges;
fastening an angle bar with unequal legs and to one long side of the bar clamp;
preparing a scoring line and straight edge along a lateral leg of said angle bar by using a particular power tool mated for its use to cut along a line parallel to a vertical leg as a fence; and
repeatedly thereafter cutting sheet materials with said particular power tool and the combined bar clamp and prepared angle bar;
wherein, a lateral leg of the angle bar provides for a scoring edge and reduced chipping during use.
